(19) United States
(12) Patent Application Publication
(10) Pub. No.: US 2025/0313074 A1
(43) Pub. Date: Oct. 9, 2025

(54) DRIVE DEVICE FOR VEHICLE

(71) Applicant: TOYOTA JIDOSHA KABUSHIKI KAISHA, Toyota-shi (JP)

(72) Inventors: Koichi OKUDA, TOYOTA-SHI (JP); Naoki ITAZU, Nagoya-shi (JP); Yuto MASUDA, Toyota-shi (JP); Taiga IKUTA, Toyota-shi (JP); Naoki SAITO, Togo-cho (JP); Kaori KIMATA, Nagoya-shi (JP)

(73) Assignee: TOYOTA JIDOSHA KABUSHIKI KAISHA, Toyota-shi (JP)

(21) Appl. No.: 18/985,735

(22) Filed: Dec. 18, 2024

(30) Foreign Application Priority Data
Apr. 8, 2024 (JP) 2024-062133

(51) Int. Cl. B60K 1/02; B60K 1/00; B60K 11/02

(52) U.S. Cl. CPC B60K 1/02; B60K 11/02; B60K 2001/006

(57) ABSTRACT

A drive device for a vehicle includes a first motor connected to one of a left wheel and a right wheel of the vehicle, a second motor connected to the other of the left wheel and the right wheel, a casing, and a first circulation circuit and a second circulation circuit for circulating the coolant in the casing. The casing has a first chamber and a second chamber. The first circulation circuit includes a first suction port provided in the first chamber, a first supply port provided in the second chamber, and a first pump for feeding the coolant from the first suction port to the first supply port. The second circulation circuit includes a second suction port provided in the second chamber, a second supply port provided in the first chamber, and a second pump for feeding the coolant from the second suction port to the second supply port.

### CROSS-REFERENCE TO RELATED APPLICATION

This application claims priority to Japanese Patent Application No. 2024-062133 filed on Apr. 8, 2024, incorporated herein by reference in its entirety.

### BACKGROUND

### 1. Technical Field

The technology disclosed herein relates to a drive device for a vehicle.

### 2. Description of Related Art

Japanese Unexamined Patent Application Publication No. 2016-205444 (JP 2016-205444 A) describes a drive device for a vehicle. This drive device drives right and left wheels independently by two motors. The casing of the drive device includes a first chamber that houses one motor and a second chamber that houses the other motor. The casing has a generally bilaterally symmetrical shape, and the first chamber and the second chamber are disposed separately in a right-left direction of the vehicle.

### SUMMARY

In the drive device for the vehicle, it is necessary to suppress an increase in temperature of the motor. Therefore, it is conceivable to cool each motor by circulating a coolant (typically a lubricating liquid) contained in the casing to each motor. For example, when the vehicle turns, the coolant in the casing may be biased to one side out of the right and left sides or the front and rear sides under a centrifugal force. In this case, the coolant is supplied sufficiently to one motor but insufficiently to the other motor, and a temperature difference may occur between the two motors. The temperature of the motor affects the characteristics of the motor. Therefore, the temperature difference between the two motors may affect the drivability of the vehicle. Such a problem may occur not only when the vehicle turns, but also when the vehicle accelerates or decelerates, or travels on a road surface inclined in the right-left direction and/or the front-rear direction depending on the positional relationship between the two motors.

The present specification provides a technology capable of suppressing a temperature difference between two motors in a drive device including the two motors.

The technology disclosed herein is embodied in a drive device for a vehicle. In one embodiment thereof,
the drive device for the vehicle may include:
a first motor connected to one of a left wheel and a right wheel of the vehicle;
a second motor connected to the other of the left wheel and the right wheel;
a casing that houses the first motor and the second motor together with a coolant; and
a first circulation circuit and a second circulation circuit configured to circulate the coolant in the casing.
The casing may include a first chamber that houses at least the first motor, and a second chamber that houses at least the second motor.
The first circulation circuit may include a first suction port provided in the first chamber, a first supply port provided in the second chamber, and a first pump configured to feed the coolant under pressure from the first suction port to the first supply port.
The second circulation circuit may include a second suction port provided in the second chamber, a second supply port provided in the first chamber, and a second pump configured to feed the coolant under pressure from the second suction port to the second supply port.

With the above configuration, the temperature difference between the two motors can be suppressed even when the coolant is biased between the first chamber and the second chamber due to turning of the vehicle, acceleration or deceleration, a gradient of a road surface, etc. For example, when the coolant moves toward the second chamber and the amount of the coolant in the first chamber decreases, the coolant is supplied from the second chamber to the first chamber through the second circulation circuit. Alternatively, when the coolant moves toward the first chamber and the amount of the coolant in the second chamber decreases, the coolant is supplied from the first chamber to the second chamber through the first circulation circuit. Accordingly, in the drive device according to the present technology, even when the coolant is biased between the first chamber and the second chamber, the coolant is supplied to each of the two motors, and the temperature difference between these motors is suppressed.

In one embodiment of the present technology,
the drive device may further include
at least one gear mechanism housed in the casing and lubricated by the coolant.
The at least one gear mechanism may be connected to at least either of the first motor and the second motor.
With such a configuration, for example, oil or any other lubricating liquid contained in the casing can be used as the coolant for cooling the motors.

In one embodiment of the present technology,
the at least one gear mechanism may include a first gear mechanism configured to transmit a torque between the first motor and the one of the left wheel and the right wheel, and a second gear mechanism configured to transmit a torque between the second motor and the other of the left wheel and the right wheel.
The first gear mechanism may be housed in the first chamber of the casing, and the second gear mechanism may be housed in the second chamber of the casing.
In another embodiment, the casing may further include a third chamber that houses the first gear mechanism and the second gear mechanism. In this case, the third chamber may be positioned between the first chamber and the second chamber in a right-left direction of the vehicle.

In one embodiment of the present technology,
the first chamber and the second chamber may be arranged along a right-left direction of the vehicle.
With such a configuration, the temperature difference between the two motors can be suppressed even when the coolant is biased between the first chamber and the second chamber due to turning of the vehicle or a gradient of a road surface in the right-left direction.

In one embodiment of the present technology,
the first suction port may be positioned on an outer side in the right-left direction of the vehicle with respect to the first motor.
The second suction port may be positioned on an outer side in the right-left direction of the vehicle with respect to the second motor.
With such a configuration, even when the coolant in the casing is greatly biased to one side in the right-left direction, the coolant can be reliably supplied from the first chamber to the second chamber or from the second chamber to the first chamber.

In one embodiment of the present technology,
the first chamber may be positioned on one side in a front-rear direction of the vehicle with respect to an axle on which the left wheel and the right wheel are disposed.
The second chamber may be positioned on the other side in the front-rear direction of the vehicle with respect to the axle on which the left wheel and the right wheel are disposed.
With such a configuration, even when the coolant in the casing moves to one side in the front-rear direction due to acceleration or deceleration of the vehicle or a gradient of a road surface, the coolant is supplied to each of the two motors, and the temperature difference between these motors is suppressed.

In one embodiment of the present technology, the at least one gear mechanism may be a single gear mechanism connected to both the first motor and the second motor. In this case, the single gear mechanism may be disposed over both the first chamber and the second chamber. The single gear mechanism may include a differential device and may be connected to both the right and left wheels of the vehicle via the differential device.

In all the embodiments disclosed herein, the positions of the first motor and the second motor in an up-down direction may be the same or different. In addition or alternatively, the positions of the first chamber and the second chamber of the casing in the up-down direction (in particular, the positions of the first suction port and the second suction port in the up-down direction) may be the same or different.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a configuration of a drive device 10 according to a first embodiment;

FIG. 2 schematically illustrates a configuration of the drive device 110 according to the second embodiment;

FIG. 3 schematically illustrates a configuration of the drive device 210 according to the third embodiment;

FIG. 4 schematically shows a configuration of a drive device 310 according to a fourth embodiment; and

FIG. 5 schematically illustrates a configuration of a drive device 410 according to a fifth embodiment.

### DETAILED DESCRIPTION OF EMBODIMENTS

### Example 1

The drive device 10 of the first embodiment will be described with reference to the drawings. The drive device 10 of the present embodiment is a drive device for the vehicle 2. The vehicle 2 is an electrified vehicle. Electrified vehicle here is, for example, a battery electrified vehicle, a hybrid electrified vehicle, a plug-in hybrid electrified vehicle, or a fuel cell electrified vehicle. The drive device 10 is mounted on the vehicle 2 and drives the left wheel 4 and the right wheel 6 of the vehicle 2. The left wheel 4 and the right wheel 6 are arranged coaxially. The left wheel 4 and the right wheel 6 may be front wheels of the 15 vehicle 2 or rear wheels of the vehicle 2.

In the drawings, the direction RH indicates a right direction in the left-right direction of the vehicle 2, and the direction LH indicates a left direction in the left-right direction. The direction FR indicates the front in the front-rear direction of the vehicle 2, and the direction RR indicates the rear in the front-rear direction. A direction perpendicular to the left-right direction and the front-rear direction, that is, a direction perpendicular to the drawing surface in each drawing indicates the up-down direction.

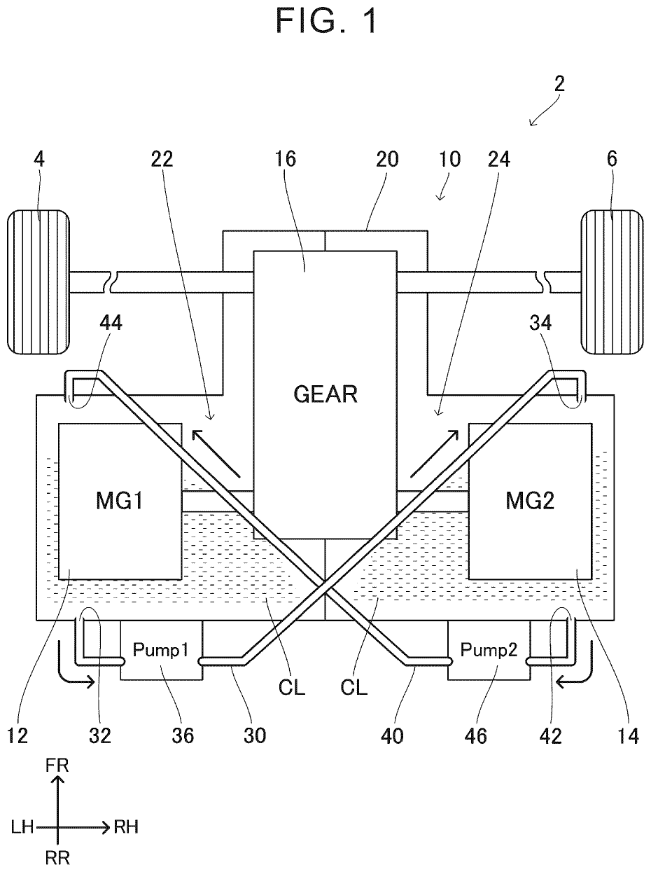

As illustrated in FIG. 1, the drive device 10 includes a first motor (MG1) 12, a second motor (MG2) 14, and a gear mechanism (GEAR) 16. The first motor 12 and the second motor 14 are prime movers for driving the left wheel 4 and the right wheel 6 of the vehicle 2. Each of the first motor 12 and the second motor 14 is connected to each of the left wheel 4 and the right wheel 6 via a gear mechanism 16.

The gear mechanism 16 transmits torque between each of the first motor 12 and the second motor 14 and each of the left wheel 4 and the right wheel 6. Although not particularly limited, the gear mechanism 16 is a speed reducer. The gear mechanism 16 may be configured to amplify the torque output from each of the motors 12 and 14 and transmit the amplified torque to the left wheel 4 and the right wheel 6. Further, the gear mechanism 16 may include a differential device (not shown), and may be connected to the left wheel 4 and the right wheel 6 via the differential device.

The drive device 10 further includes a casing 20. The casing 20 houses the first motor 12, the second motor 14, and the gear mechanism 16 together with the coolant CL. The coolant CL may be a lubricating fluid such as, for example, a lubricating oil. The casing 20 has a first chamber 22 and a second chamber 24. The first chamber 22 is located on the left side of the casing 20 and houses the first motor 12. The second chamber 24 is located on the right side of the casing 20 and houses the second motor 14. The gear mechanism 16 is disposed over both the first chamber 22 and the second chamber 24. The first chamber 22 and the second chamber 24 are not completely isolated, and coolant CL can flow between the first chamber 22 and the second chamber 24.

The drive device 10 further includes a first circulation circuit 30. The first circulation circuit 30 includes a first suction port 32, a first supply port 34, and a first pump (Pump1) 36. The first suction port 32 is provided in the first chamber 22, and is configured to be capable of sucking the coolant CL in the first chamber 22. The first supply port 34 is provided in the second chamber 24, and is configured to be capable of supplying the coolant CL into the second chamber 24. The first pump 36 is configured to pump the coolant CL from the first suction port 32 to the first supply port 34. With such a configuration, the first circulation circuit 30 can supply the coolant CL from the first chamber 22 to the second chamber 24. Accordingly, the second motor 14 in the second chamber 24 is cooled by the coolant CL.

Although not particularly limited, the first pump 36 may be an electric pump having a motor. Alternatively, the first pump 36 may be connected to the first motor 12 or the gear mechanism 16 and driven by the first motor 12 or the gear mechanism 16. The first supply port 34 may be directly connected to the second motor 14 in the second chamber 24. In this case, the first supply port 34 may be directly connected to the stator of the first motor 12 or the center shaft of the rotor. Further, the first circulation circuit 30 may be provided with a cooler (for example, an oil cooler) for cooling the coolant CL.

The drive device 10 further includes a second circulation circuit 40. The second circulation circuit 40 includes a second suction port 42, a second supply port 44, and a second pump (Pump2) 46. The second suction port 42 is provided in the second chamber 24, and is configured to be capable of sucking the coolant CL in the second chamber 24. The second supply port 44 is provided in the first chamber 22, and is configured to be capable of supplying the coolant CL into the first chamber 22. The second pump 46 is configured to pump the coolant CL from the second suction port 42 to the second supply port 44. With such a configuration, the second circulation circuit 40 can supply the coolant CL from the second chamber 24 to the first chamber 22. Thus, the first motor 12 in the first chamber 22 is cooled by the coolant CL.

Although not particularly limited, the second pump 46 may be an electric pump having a motor. Alternatively, the second pump 46 may be connected to the second motor 14 or the gear mechanism 16 and driven by the second motor 14 or the gear mechanism 16. The second supply port 44 may be directly connected to the first motor 12 in the first chamber 22. In this case, the second supply port 44 may be directly connected to the stator of the second motor 14 or the center shaft of the rotor. Further, the second circulation circuit 40 may be provided with a cooler (for example, an oil cooler) for cooling the coolant CL.

With the above-described configuration, the drive device 10 of the present embodiment can cool the two motors 12 and 14 equally even when the vehicle 2 turns in any direction. That is, when the vehicle 2 turns in either direction, the coolant CL in the casing 20 moves to one of the left and right. Consequently, the coolant CL is reduced in one of the first chamber 22 and the second chamber 24. However, for example, when the coolant CL in the first chamber 22 is reduced, the coolant CL is supplied from the second chamber 24 to the first chamber 22 through the second circulation circuit 40. As a result, cooling of the first motor 12 is maintained. Conversely, when the coolant CL in the second chamber 24 is reduced, the coolant CL is supplied from the first chamber 22 to the second chamber 24 through the first circulation circuit 30. As a result, cooling of the first motor 12 is maintained. As described above, in the drive device 10 of the present embodiment, the coolant CL is supplied to each of the two motors 12 and 14 even when the vehicle 2 turns. As a result, the temperature difference between the two motors 12 and 14 is suppressed.

### Example 2

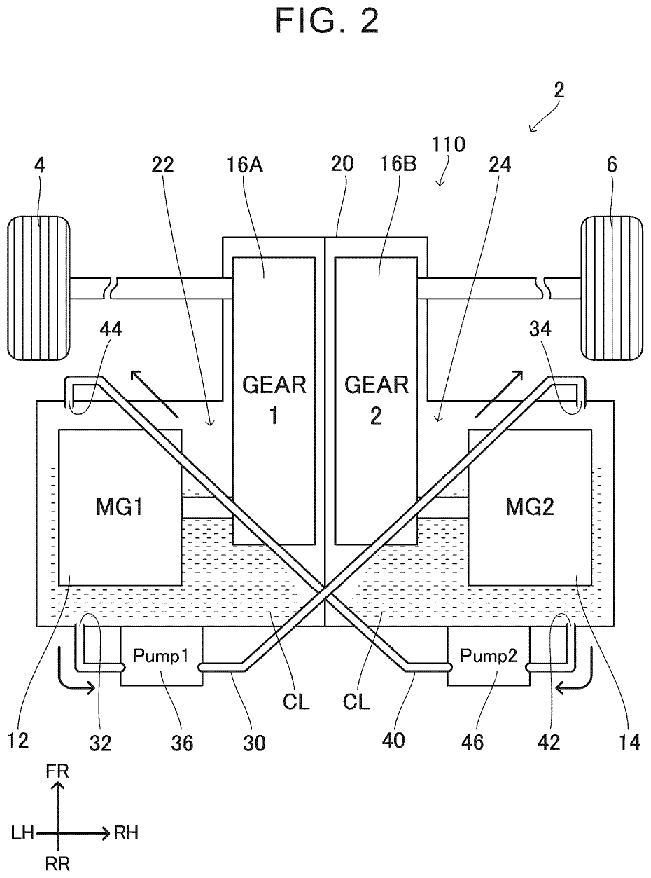

The drive device 110 of the second embodiment will be described with reference to FIG. 2. The drive device 110 of the present embodiment is obtained by changing the configuration of the gear mechanism 16 in the drive device 10 of the first embodiment. In the following description, configurations common to or corresponding to the drive device 10 of the first embodiment are denoted by the same reference numerals, and redundant description will be avoided. That is, all the descriptions in the first embodiment are also incorporated in the drive device 110 of the present embodiment, as long as they are not inconsistent with the descriptions described below.

The drive device 110 of the present embodiment includes a first gear mechanism (GEAR1) 16A and a second gear mechanism (GEAR2) 16B in place of the gear mechanism 16 of the first embodiment. The first gear mechanism 16A is connected to the first motor 12 and transmits torque between the first motor 12 and the left wheel 4. The second gear mechanism 16B is connected to the second motor 14 and transmits torque between the second motor 14 and the right wheel 6. Thus, the drive device 110 can independently drive the left wheel 4 and the right wheel 6 of the vehicle 2 by the two motors 12 and 14.

The first gear mechanism 16A is accommodated in the first chamber 22 of the casing 20. Therefore, the coolant CL supplied from the second chamber 24 to the first chamber 22 through the second circulation circuit 40 contributes not only to cooling of the first motor 12 but also to cooling and lubricating of the first gear mechanism 16A. Similarly, the second gear mechanism 16B is housed in the second chamber 24 of the casing 20. Therefore, the coolant CL supplied from the first chamber 22 to the second chamber 24 through the first circulation circuit 30 contributes not only to cooling of the second motor 14 but also to cooling and lubricating of the second gear mechanism 16B. According to the drive device 110 of the present embodiment, even when the vehicle 2 turns in any direction, it is possible to suppress the temperature differences occurring in the two motors 12 and 14, and also to smooth the cooling and lubrication of the two gear mechanisms 16A, 16B. According to the drive device 110 of the present embodiment, even when the vehicle 2 travels on a road surface inclined in the left-right direction, it is possible to suppress temperature differences occurring in the two motors 12 and 14, and also to achieve smoothing of cooling and lubrication for the two gear mechanisms 16A, 16B.

### Example 3

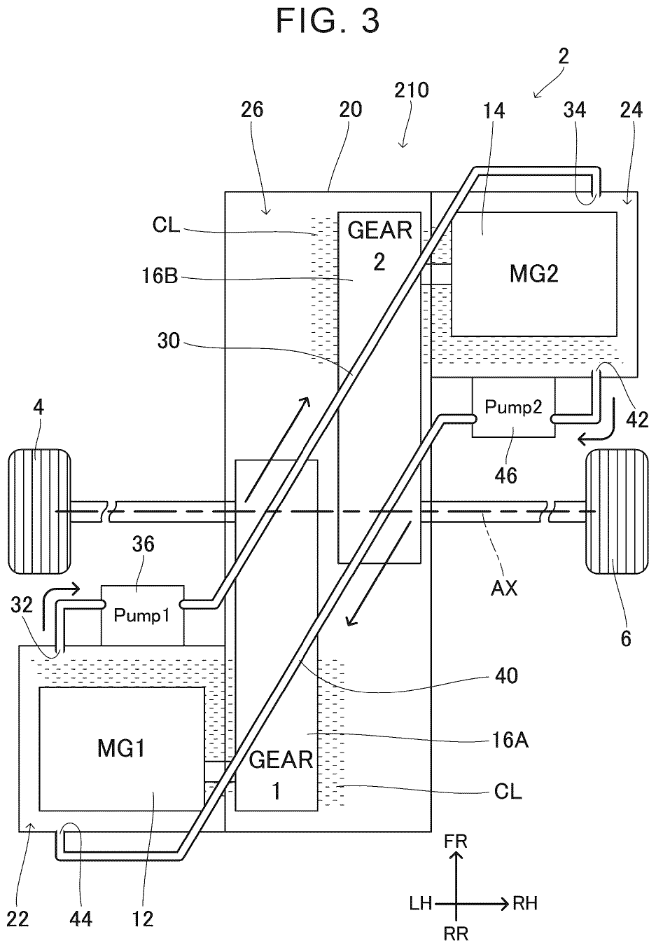

Referring to FIG. 3, the drive device 210 of the third embodiment will be described. The drive device 310 of the present embodiment is obtained by changing the configuration of the casing 20 in the drive device 110 of the second embodiment. In the following description, configurations common to or corresponding to the drive device 110 of the second embodiment are denoted by the same reference numerals, and redundant description will be avoided. That is, all the descriptions in the first and second embodiments are also incorporated in the drive device 210 of the present embodiment as long as they are not inconsistent with the descriptions described below.

In the drive device 210 of the present embodiment, the casing 20 further includes a third chamber 26 in addition to the first chamber 22 and the second chamber 24. The third chamber 26 is located between the first chamber 22 and the second chamber 24 in the left-right direction of the vehicle 2. The third chamber 26 is not completely isolated from either the first chamber 22 or the second chamber 24. The coolant CL can flow between the third chamber 26 and the first chamber 22 and between the third chamber 26 and the second chamber 24. The first gear mechanism 16A and the second gear mechanism 16B are accommodated in the third chamber 26.

In addition, in the drive device 210 of the present embodiment, the first chamber 22 of the casing 20 is located at the rear side (RR) of the vehicle 2 in the front-rear direction with respect to the axle AX in which the left wheel 4 and the right wheel 6 are disposed. Therefore, the first motor 12 accommodated in the first chamber 22, the first suction port 32 provided in the first chamber 22, and the second supply port 44 provided in the first chamber 22 are also located rearward with respect to the axle AX. On the other hand, the second chamber 24 of the casing 20 is positioned forward (FR) in the front-rear direction of the vehicle 2 with respect to the axle AX. Therefore, the second motor 14 housed in the second chamber 24, the second suction port 42 provided in the second chamber 24, and the first supply port 34 provided in the second chamber 24 are also positioned forward with respect to the axle AX. As a modification, the first chamber 22 may be positioned forward with respect to the axle AX, and the second chamber 24 may be positioned rearward with respect to the axle AX.

When the vehicle 2 accelerates or decelerates or the road surface is inclined in the front-rear direction, the coolant CL in the casing 20 moves to one side in the front-rear direction. Alternatively, when the vehicle 2 turns or the road surface is inclined in the left-right direction, the coolant CL in the casing 20 moves to one side in the left-right direction. In these cases, in the drive device 210 of the present embodiment, the coolant CL is reduced in one of the first chamber 22 and the second chamber 24. However, for example, when the coolant CL in the first chamber 22 is reduced, the coolant CL is supplied from the second chamber 24 to the first chamber 22 through the second circulation circuit 40. As a result, cooling of the first motor 12 is maintained. Conversely, when the coolant CL in the second chamber 24 is reduced, the coolant CL is supplied from the first chamber 22 to the second chamber 24 through the first circulation circuit 30. As a result, cooling of the first motor 12 is maintained. In the drive device 210 of the present embodiment, the coolant CL is supplied to each of the two motors 12 and 14 even when the coolant CL in the casing 20 is moved in the front-rear direction and/or the left-right direction by the turning and the acceleration and deceleration of the vehicle 2. As a result, a temperature difference occurring in the motors 12 and 14 is suppressed. In the drive device 210 of the present embodiment, the coolant CL is supplied to each of the two motors 12 and 14 even when the coolant CL in the casing 20 moves in the front-rear direction and/or the left-right direction due to the slope of the road surface. As a result, a temperature difference occurring in the motors 12 and 14 is suppressed.

The configuration described in the third embodiment can be applied to the first and second embodiments. That is, in the drive devices 10 and 110 of the first and second embodiments, the first chamber 22 may be positioned on one side in the front-rear direction of the vehicle 2 with respect to the axle AX of the left wheel 4 and the right wheel 6. The second chamber 24 may be located on the other side in the front-rear direction of the vehicle 2 with respect to the axle AX.

Here, in the drive device 210 of the present embodiment, the first chamber 22 is located on the left side of the third chamber 26, and the second chamber 24 is located on the right side of the third chamber 26. However, in other embodiments, the first chamber 22 may be located to the right of the third chamber 26 and the second chamber 24 may be located to the left of the third chamber 26. In either form, the first chamber 22 and the second chamber 24 are not coaxially positioned, but can be said to be arranged along the left-right direction. However, both the first chamber 22 and the second chamber 24 may be disposed on one of the left side and the right side of the third chamber 26. In this case, the first chamber 22 and the second chamber 24 may be arranged at least partially along the front-rear direction. Even in such a configuration, it is preferable that one of the first chamber 22 and the second chamber 24 is positioned forward with respect to the axle AX, and the other of the first chamber 22 and the second chamber 24 is positioned rearward with respect to the axle AX.

### Example 4

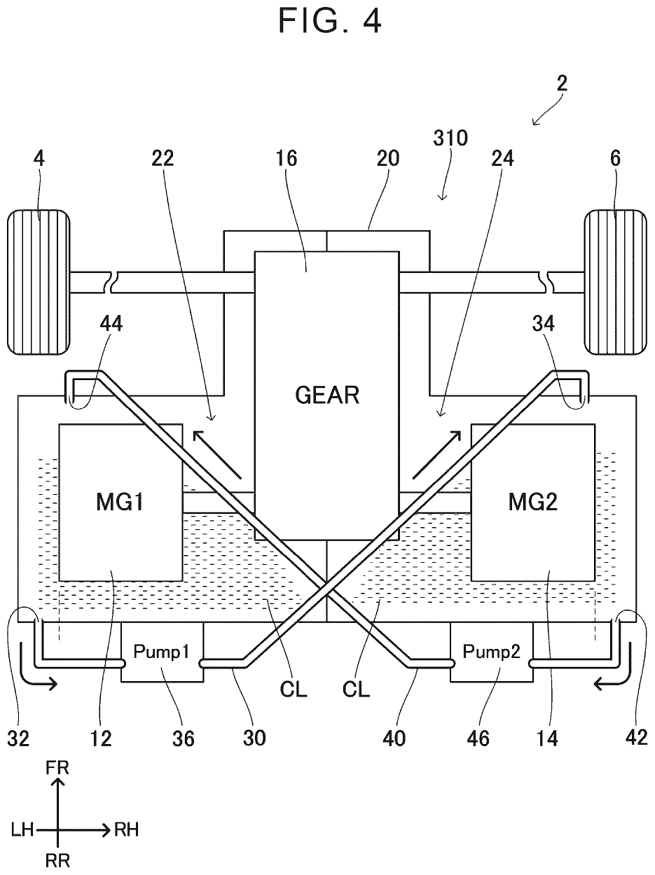

The drive device 310 of the fourth embodiment will be described with reference to FIG. 4. In the drive device 410 of the present embodiment, the positions of the first suction port 32 and the second suction port 42 are changed in the drive device 10 of the first embodiment. In the following description, configurations common to or corresponding to the drive device 10 of the first embodiment are denoted by the same reference numerals, and redundant description will be avoided. That is, all the descriptions in the first, second, and third embodiments are also incorporated in the drive device 310 of the present embodiment as long as they are not inconsistent with the descriptions described below.

In the drive device 310 of the present embodiment, the first suction port 32 is located on the outer side (i.e., the left side) of the first motor 12 in the left-right direction of the vehicle 2. Similarly, the second suction port 42 is located on the outer side (that is, the right side) of the vehicle 2 in the left-right direction relative to the second motor 14. According to such a configuration, even when the coolant CL in the casing 20 largely deviates to one of the left and right directions, the coolant CL can be reliably supplied from the first chamber 22 to the second chamber 24 or from the second chamber 24 to the first chamber 22.

The configuration described in the fourth embodiment can be applied to any of the first, second, and third embodiments. That is, in the drive devices 10, 110, and 210 of the first embodiment, the second embodiment, and the third embodiment, the first suction port 32 may be located outside (i.e., on the left side) of the first motor 12 in the left-right direction of the vehicle 2. Similarly, the second suction port 42 may be located on the outer side (that is, the right side) of the vehicle 2 in the left-right direction relative to the second motor 14.

### Example 5

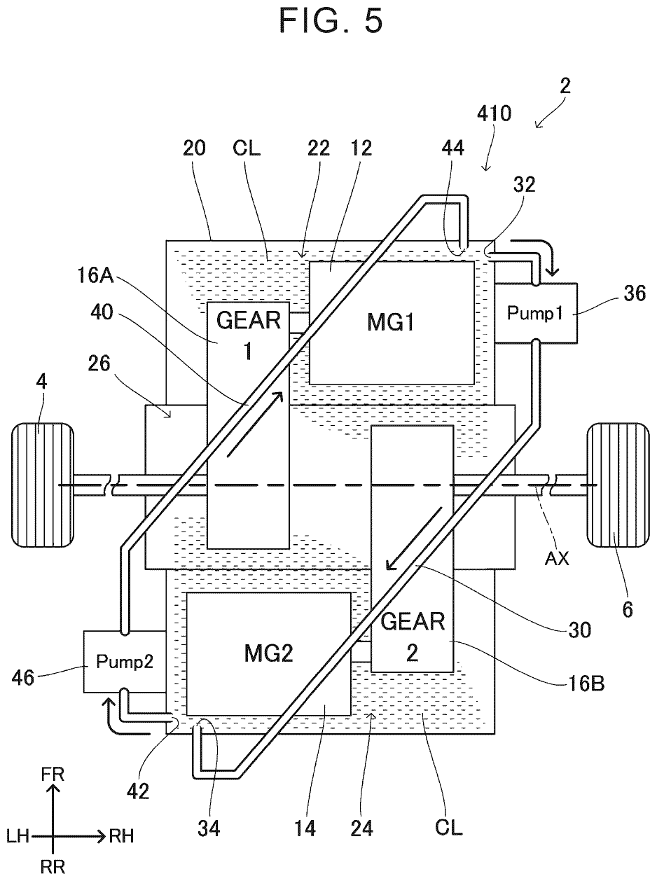

The drive device 410 of the fifth embodiment will be described with reference to FIG. 5. The drive device 510 of the present embodiment is obtained by changing the configuration of the casing 20 in the drive device 210 of the third embodiment. In the following description, configurations common to or corresponding to the drive device 210 of the third embodiment are denoted by the same reference numerals, and redundant description will be avoided. That is, all the descriptions in the third embodiment are also incorporated in the drive device 410 of the present embodiment, as long as they are not inconsistent with the descriptions described below.

In the drive device 410 of the present embodiment, the first chamber 22 of the casing 20 is positioned forward (FR) of the vehicle 2 in the front-rear direction with respect to the axle AX in which the left wheel 4 and the right wheel 6 are disposed. Therefore, the first motor 12 housed in the first chamber 22, the first suction port 32 provided in the first chamber 22, and the second supply port 44 provided in the first chamber 22 are also positioned forward with respect to the axle AX. On the other hand, the second chamber 24 of the casing 20 is located on the rear side (RR) of the vehicle 2 in the front-rear direction with respect to the axle AX. Accordingly, the second motor 14 accommodated in the second chamber 24, the second suction port 42 provided in the second chamber 24, and the first supply port 34 provided in the second chamber 24 are also located rearward with respect to the axle AX. As a modification, the first chamber 22 may be positioned rearward with respect to the axle AX, and the second chamber 24 may be positioned forward with respect to the axle AX.

In the drive device 410 of the present embodiment, the casing 20 includes the third chamber 26 as in the third embodiment. However, the third chamber 26 in the present embodiment is located between the first chamber 22 and the second chamber 24 in the front-rear direction of the vehicle 2. Thus, the first chamber 22 is positioned forward with respect to the third chamber 26, and the second chamber 24 is positioned rearward with respect to the third chamber 26. The third chamber 26 is not completely isolated from either the first chamber 22 or the second chamber 24. The coolant CL can flow between the third chamber 26 and the first chamber 22 and between the third chamber 26 and the second chamber 24. This point is common to the drive device 210 of the third embodiment. However, the first gear mechanism 16A is disposed over the first chamber 22 and the third chamber 26, and the second gear mechanism 16B is disposed over the second chamber 24 and the third chamber 26.

When the vehicle 2 accelerates or decelerates or the road surface is inclined in the front-rear direction, the coolant CL in the casing 20 moves to one side in the front-rear direction. In the drive device 410 of the present embodiment, the coolant CL is reduced in one of the first chamber 22 and the second chamber 24. However, for example, when the coolant CL in the first chamber 22 is reduced, the coolant CL is supplied from the second chamber 24 to the first chamber 22 through the second circulation circuit 40. As a result, cooling of the first motor 12 is maintained. Conversely, when the coolant CL in the second chamber 24 is reduced, the coolant CL is supplied from the first chamber 22 to the second chamber 24 through the first circulation circuit 30. As a result, cooling of the first motor 12 is maintained. In the drive device 410 of the present embodiment, the coolant CL is supplied to each of the two motors 12 and 14 even when the coolant CL in the casing 20 is moved in the front-rear direction by the acceleration and deceleration of the vehicle 2. As a result, a temperature difference occurring in the motors 12 and 14 can be suppressed. In the drive device 410 of the present embodiment, the coolant CL is supplied to each of the two motors 12 and 14 even when the coolant CL in the casing 20 is moved in the front-rear direction due to the slope of the road surface. As a result, a temperature difference occurring in the motors 12 and 14 can be suppressed.

What is claimed is:

1. A drive device for a vehicle, the drive device comprising:
a first motor connected to one of a left wheel and a right wheel of the vehicle;
a second motor connected to the other of the left wheel and the right wheel;
a casing that houses the first motor and the second motor together with a coolant; and
a first circulation circuit and a second circulation circuit configured to circulate the coolant in the casing, wherein
the casing includes a first chamber that houses at least the first motor, and a second chamber that houses at least the second motor,
the first circulation circuit includes a first suction port provided in the first chamber, a first supply port provided in the second chamber, and a first pump configured to feed the coolant under pressure from the first suction port to the first supply port, and
the second circulation circuit includes a second suction port provided in the second chamber, a second supply port provided in the first chamber, and a second pump configured to feed the coolant under pressure from the second suction port to the second supply port.

2. The drive device according to claim 1, further comprising at least one gear mechanism housed in the casing and lubricated by the coolant, wherein the at least one gear mechanism is connected to at least either of the first motor and the second motor.

3. The drive device according to claim 2, wherein:
the at least one gear mechanism includes a first gear mechanism configured to transmit a torque between the first motor and the one of the left wheel and the right wheel, and a second gear mechanism configured to transmit a torque between the second motor and the other of the left wheel and the right wheel; and
the first gear mechanism is housed in the first chamber of the casing, and the second gear mechanism is housed in the second chamber of the casing.

4. The drive device according to claim 1, wherein the first chamber and the second chamber are arranged along a right-left direction of the vehicle.

5. The drive device according to claim 4, wherein:
the first suction port is positioned on an outer side in the right-left direction of the vehicle with respect to the first motor; and
the second suction port is positioned on an outer side in the right-left direction of the vehicle with respect to the second motor.

6. The drive device according to claim 1, wherein:
the first chamber is positioned on one side in a front-rear direction of the vehicle with respect to an axle on which the left wheel and the right wheel are disposed; and
the second chamber is positioned on the other side in the front-rear direction of the vehicle with respect to the axle on which the left wheel and the right wheel are disposed.
